(19) United States
(12) Patent Application Publication
(10) Pub. No.: US 2025/0391430 A1
(43) Pub. Date: Dec. 25, 2025

(54) Dual Free Layer TMR Reader with Shaped Rear Bias and Methods of Forming Thereof

(71) Applicant: Western Digital Technologies, Inc., San Jose, CA (US)

(72) Inventors: Ming MAO, Dublin, CA (US); Chen-Jung CHIEN, Mountain View, CA (US); James Mac FREITAG, Sunnyvale, CA (US); Chih-Ching HU, Pleasanton, CA (US); Yung-Hung WANG, San Jose, CA (US)

(73) Assignee: Western Digital Technologies, Inc., San Jose, CA (US)

(21) Appl. No.: 18/749,413

(22) Filed: Jun. 20, 2024

(51) Int. Cl. G11B 5/147

(52) U.S. Cl. CPC G11B 5/147

(57) ABSTRACT

The present disclosure generally relates to a dual free layer (DFL) read head with a shaped rear bias (RB) and methods of forming thereof. A shaped rear hard bias (RHB) or a shaped rear soft bias (RSB) can induce large transverse magnetic anisotropy and align bias element magnetization, which in turn contributes to overcoming polarity flip or negative amplitude observed in DFL read heads. However, often, the removal time of exposed portions of RB are greater than the removal time of exposed portions of the DFL sensor. Thus, depositing a stitch layer over a DFL sensor to adjust the etching rate of the DFL sensor to match the etching rate of the RB during the removal processes provides sufficient time to remove exposed portions of the RB without damaging the DFL sensor, thereby improving shaped RHB or RSB control and reliability in DFL sensors.

### BACKGROUND OF THE DISCLOSURE

### Field of the Disclosure

Embodiments of the present disclosure generally relate to a dual free layer (DFL) read head and methods of forming thereof.

### Description of the Related Art

DFL read heads generally comprise two free layers. In DFL reader operation, the two free layers are individually stabilized longitudinally by an anti-ferromagnetically coupled (AFC) soft bias (SB) and biased transversally by a permanent magnet or a rear hard bias (RHB) structure from the stripe back edge of the sensor. Recently, the track width of the dual free layer read heads have been decreasing. However, the smaller track width of the DFL read heads can limit performance of the DFL read heads, as the signal-to-noise ratio may degrade.

Moreover, a transverse bias field of DFL read heads is determined by the remnant magnetization (Mr) times thickness (t) product (i.e., Mr*t) of the RHB structure. Since a saturation magnetization, Ms, and thus, the Mr of the RHB is quite limited (e.g., as compared to the Ms of the soft bias), a thicker RHB is generally required to achieve the desired transverse bias field. However, the thicker RHBs may certainly result in a larger undesirable topography along the stripe direction, and in turn limit DFL readers for two-dimensional magnetic recording (TDMR) applications. In addition, a large RHB comprising a granular material may result in an unintended read-out signal polarity flip due to the RHB biasing direction flip, further negatively impacting the overall performance and reliability of the DFL read heads. Furthermore, the granular nature of a large sized RHB certainly determines the transversal bias field with intrinsic non-uniformity and the limitation to read heads with smaller track widths for higher areal recording density due to significant performance degradations.

Therefore, there is a need in the art for an improved DFL read head.

### SUMMARY OF THE DISCLOSURE

The present disclosure generally relates to a dual free layer (DFL) read head with a shaped rear bias (RB) and methods of forming thereof. A shaped rear hard bias (RHB) or a shaped rear soft bias (RSB) can induce large transverse magnetic anisotropy and align bias element magnetization, which in turn contributes to overcoming polarity flip or negative amplitude observed in DFL read heads. However, often, the removal time of exposed portions of RB are greater than the removal time of exposed portions of the DFL sensor. Thus, depositing a stitch layer over a DFL sensor to adjust the etching rate of the DFL sensor to match the etching rate of the RB during the removal processes provides sufficient time to remove exposed portions of the RB without damaging the DFL sensor, thereby improving shaped RHB or RSB control and reliability in DFL sensors.

In one embodiment, a method of forming a dual free layer (DFL) read head includes forming a DFL sensor, the DFL sensor being disposed at a media facing surface; disposing a stitch layer over the DFL sensor; forming a rear bias (RB) adjacent to the DFL sensor, the RB being recessed from the media facing surface; and defining portions of the stitch layer, the DFL sensor, and the RB, an etch rate of the stitch layer being equal to or greater than an etch rate of the RB.

In another embodiment, a dual free layer (DFL) read head includes a DFL sensor, the DFL sensor being disposed at a media facing surface, the DFL sensor comprising a first shield, two free layers disposed over the first shield, and a second shield disposed over the two free layers; a stitch layer disposed over the DFL sensor, the stitch layer having an etch rate that is lower than that of other layers in the DFL sensor; and a rear bias (RB) adjacent to the DFL sensor, the RB being recessed from the media facing surface.

In yet another embodiment, a dual free layer (DFL) read head includes a means for reading data disposed at a media facing surface (MFS), the means for reading data comprising: a first shield; a seed layer disposed over the first shield; a first free layer disposed over the seed layer; a barrier layer disposed over the first free layer; a second free layer disposed over the barrier layer; a second shield disposed over the second free layer; and a stitch layer disposed over the second free layer; and a rear bias (RB) adjacent to the means for reading data, the RB being recessed from the media facing surface.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 illustrates a disk drive embodying this disclosure.

FIG. 2 is a fragmented, cross-sectional side view through the center of a read/write head facing a magnetic media, according to one or more embodiments.

FIGS. 3A-3B illustrate a plan view of a dual free layer (DFL) read head, according to one or more embodiments.

FIGS. 4A-4J illustrate a perspective view of a method of forming a DFL read head with a shaped RB, according to one or more embodiments.

FIG. 5 illustrate a top plan view of a DFL read head with a shaped RB, according to one or more embodiments.

FIGS. 6A-6B depict photos demonstrating the milling/removal of the exposed portions of the rear bias, according to one or more embodiments.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

In the following, reference is made to embodiments of the disclosure. However, it should be understood that the disclosure is not limited to specific described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments and advantages are merely illustrative and are not considered elements or limitations of the appended claims except where explicitly recited in a claim(s). Likewise, reference to “the disclosure” shall not be construed as a generalization of any inventive subject matter disclosed herein and shall not be considered to be an element or limitation of the appended claims except where explicitly recited in a claim(s).

The present disclosure generally relates to a dual free layer (DFL) read head with a shaped rear bias (RB) and methods of forming thereof. A shaped rear hard bias (RHB) or a shaped rear soft bias (RSB) can induce large transverse magnetic anisotropy and align bias element magnetization, which in turn contributes to overcoming polarity flip or negative amplitude observed in DFL read heads. However, often, the removal time of exposed portions of RB are greater than the removal time of exposed portions of the DFL sensor. Thus, depositing a stitch layer over a DFL sensor to adjust the etching rate of the DFL sensor to match the etching rate of the RB during the removal processes provides sufficient time to remove exposed portions of the RB without damaging the DFL sensor, thereby improving shaped RHB or RSB control and reliability in DFL sensors.

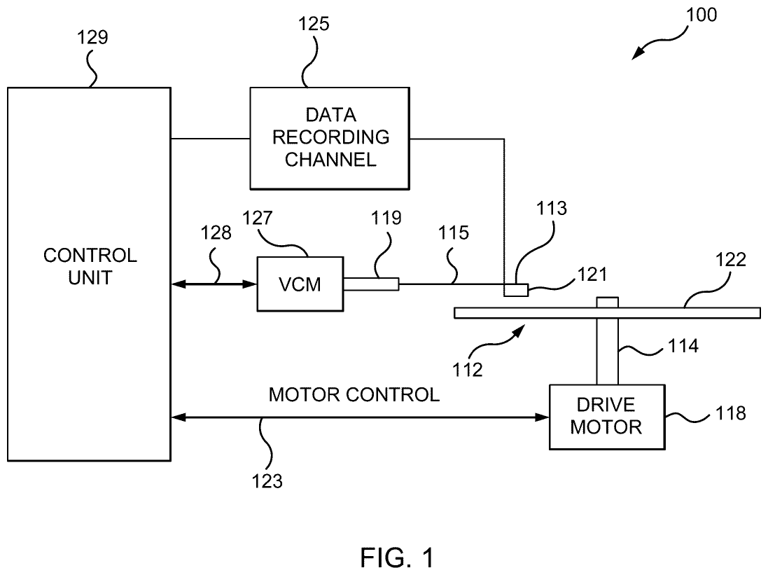

FIG. 1 is a schematic illustration of a magnetic recording device 100, according to one implementation. The magnetic recording device 100 includes a magnetic recording head, such as a write head. The magnetic recording device 100 is a magnetic media drive, such as a hard disk drive (HDD). Such magnetic media drives may be a single drive/device or include multiple drives/devices. For the ease of illustration, a single disk drive is shown as the magnetic recording device 100 in the implementation illustrated in FIG. 1. The magnet recording device 100 (e.g., a disk drive) includes at least one rotatable magnetic disk 112 supported on a spindle 114 and rotated by a drive motor 118. The magnetic recording on each rotatable magnetic disk 112 is in the form of any suitable patterns of data tracks, such as annular patterns of concentric data tracks on the rotatable magnetic disk 112.

At least one slider 113 is positioned near the rotatable magnetic disk 112. Each slider 113 supports a head assembly 121. The head assembly 121 includes one or more magnetic recording heads (such as read/write heads), such as a write head including a spintronic device. As the rotatable magnetic disk 112 rotates, the slider 113 moves radially in and out over the disk surface 122 so that the head assembly 121 may access different tracks of the rotatable magnetic disk 112 where desired data are written. Each slider 113 is attached to an actuator arm 119 by way of a suspension 115. The suspension 115 provides a slight spring force which biases the slider 113 toward the disk surface 122. Each actuator arm 119 is attached to an actuator 127. The actuator 127 as shown in FIG. 1 may be a voice coil motor (VCM). The VCM includes a coil movable within a fixed magnetic field, the direction and speed of the coil movements being controlled by the motor current signals supplied by a control unit 129.

The head assembly 121, such as a write head of the head assembly 121, includes a media facing surface (MFS) such as an air bearing surface (ABS) that faces the disk surface 122. During operation of the magnetic recording device 100, the rotation of the rotatable magnetic disk 112 generates an air or gas bearing between the slider 113 and the disk surface 122 which exerts an upward force or lift on the slider 113. The air or gas bearing thus counter-balances the slight spring force of suspension 115 and supports the slider 113 off and slightly above the disk surface 122 by a small, substantially constant spacing during operation.

The various components of the magnetic recording device 100 are controlled in operation by control signals generated by control unit 129, such as access control signals and internal clock signals. The control unit 129 includes logic control circuits, storage means and a microprocessor. The control unit 129 generates control signals to control various system operations such as drive motor control signals on a line 123 and head position and seek control signals on a line 128. The control signals on line 128 provide the desired current profiles to optimally move and position slider 113 to the desired data track on rotatable magnetic disk 112. Write and read signals are communicated to and from the head assembly 121 by way of recording channel 125. In one embodiment, which can be combined with other embodiments, the magnetic recording device 100 may further include a plurality of media, or disks, a plurality of actuators, or a plurality number of sliders.

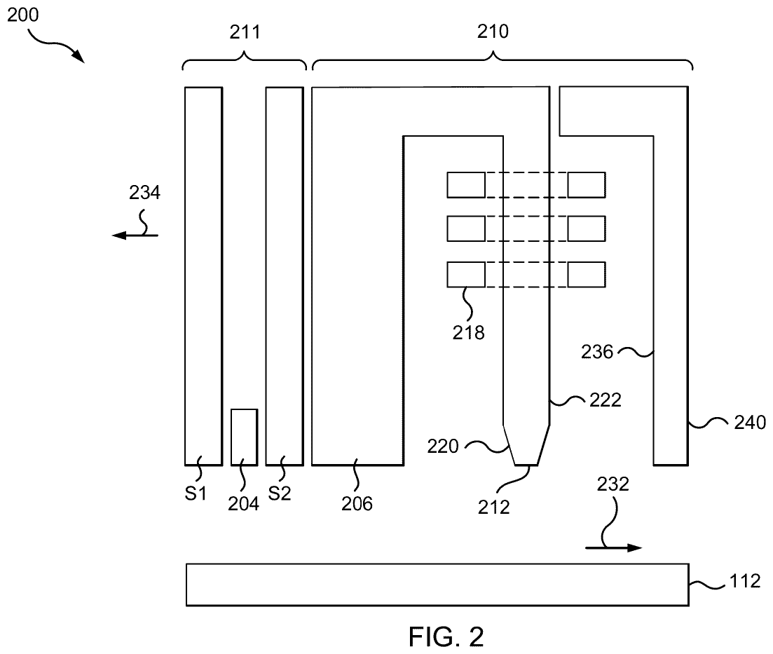

FIG. 2 is a fragmented, cross sectional side view through the center of a read/write head 200 facing the magnetic media 112, according to one embodiment. The read/write head 200 may correspond to the magnetic head assembly 121 described in FIG. 1. The read/write head 200 includes a media facing surface (MFS) 212, such as an air bearing surface (ABS), a magnetic write head 210, and a magnetic read head 211, and is mounted such that the MFS 212 is facing the magnetic media 112. The read/write head 200 may be an energy-assisted magnetic recording (EAMR) head such as a heat-assisted magnetic recording (HAMR) head or a perpendicular magnetic recording (PMR) head. In FIG. 2, the magnetic media 112 moves past the write head 210 in the direction indicated by the arrow 232 and the read/write head 200 moves in the direction indicated by the arrow 234.

In some embodiments, the magnetic read head 211 is a DFL reader 204 located between the shields S1 and S2. The magnetic fields of the adjacent magnetized regions in the magnetic media 112 are detectable by the DFL reader 204 as the recorded bits.

The write head 210 includes a return pole 206, a main pole 220, a trailing shield 240, and a coil 218 that excites the main pole 220. The coil 218 may have a “pancake” structure which winds around a back-contact between the main pole 220 and the return pole 206, instead of a “helical” structure shown in FIG. 2. A trailing gap (not shown) and a leading gap (not shown) may be in contact with the main pole and a leading shield (not shown) may be in contact with the leading gap. A recording magnetic field is generated from the main pole 220 and the trailing shield 240 helps making the magnetic field gradient of the main pole 220 steep. The main pole 220 may be a magnetic material such as a FeCo alloy. The main pole 220 may include a trailing surface 222 which may be parallel to a leading surface 236 of the trailing shield 240. The main pole 220 may be a tapered write pole (TWP) with a trailing edge taper (TET) configuration. In one embodiment, the main pole 220 has a saturated magnetization (Ms) of 2.4 T and a thickness of about 300 nanometers (nm). The main pole 220 may comprise ferromagnetic materials, typically alloys of one or more of Co, Fe, and Ni. The trailing shield 240 may be a magnetic material such as NiFe alloy. In one embodiment, the trailing shield 240 has an Ms of about 1.2 T to about 1.6 T.

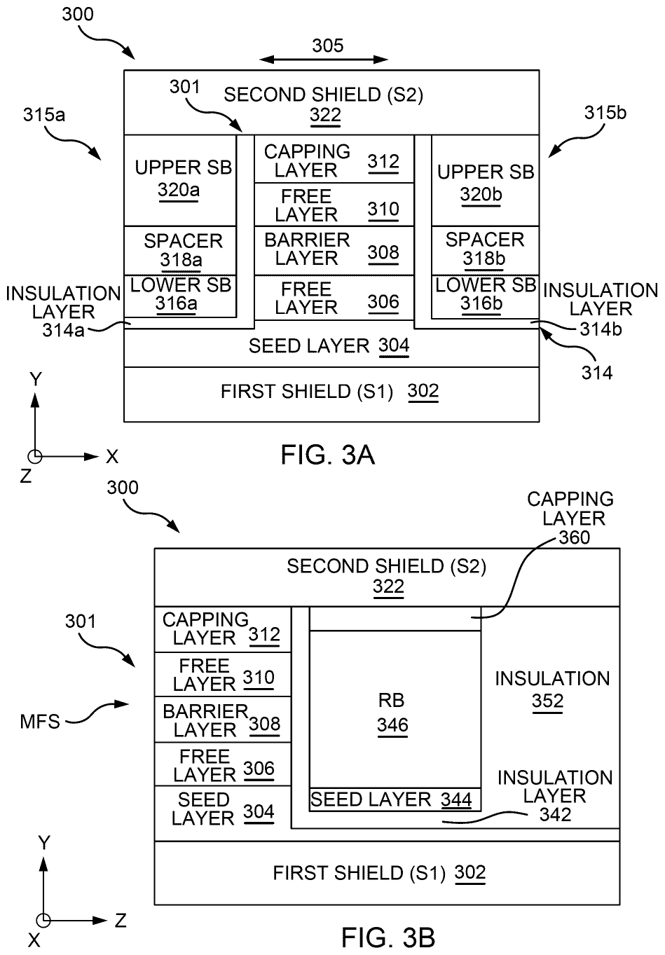

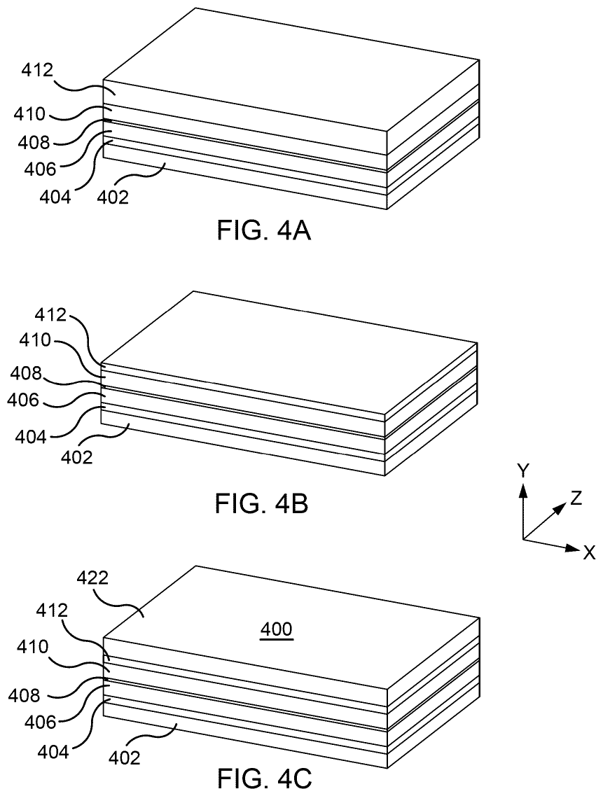

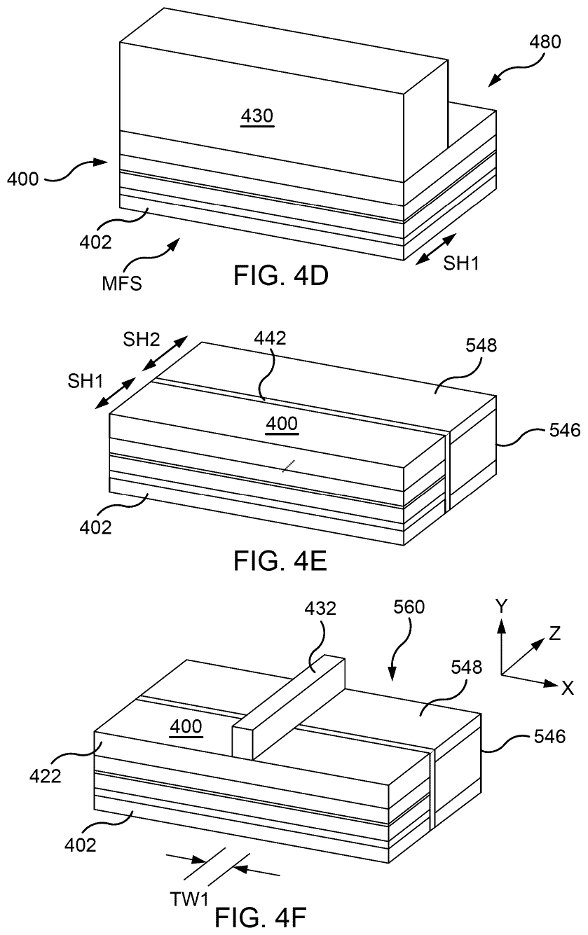

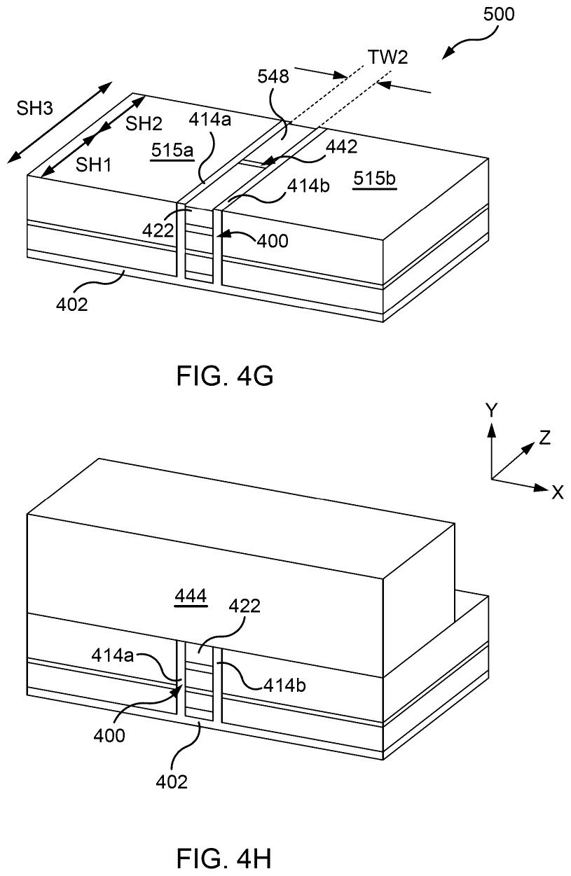

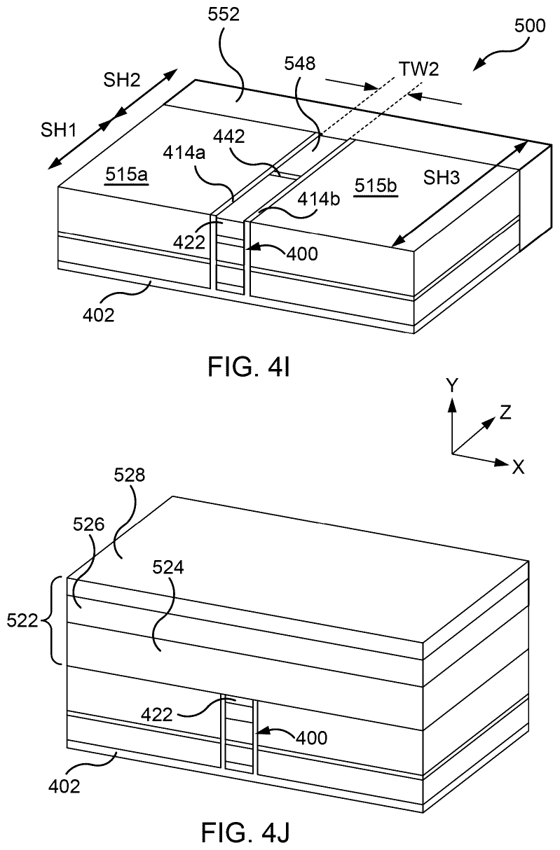

FIGS. 3A-3B illustrate a dual free layer (DFL) read head 300, according to one embodiment. FIG. 3A illustrates a media facing surface (MFS) view of the DFL read head 300, and FIG. 3B illustrates an APEX (i.e., a vertical cross-sectional) view of the DFL read head 300. The DFL read head 300 may correspond to, or be a part of, the magnetic head assembly 121 described in FIG. 1. The DFL read head 300 may correspond to, or be a part of, the read/write head 200 described in FIG. 2, such as the magnetic read head 211. The DFL read head 300 may be formed as described below in FIGS. 4A-4H.

The DFL read head 300 includes a first shield (S1) 302, a seed layer 304, a first free layer (FL) 306, a barrier layer 308, a second FL 310, a capping layer 312, and a second shield (S2) 322. The seed layer 304, the first FL 306, the barrier layer 308, the second FL 310 and the capping layer 312 form a DFL read sensor 301 of the DFL read head 300. The DFL read sensor 301 has a track width 305 in the x-direction of about 10 nm to about 30 nm±about 2 nm. The seed layer 304 includes a material selected from the group that includes tantalum (Ta), ruthenium (Ru), titanium (Ti), cobalt hafnium (CoHf), or combinations thereof. In one embodiment, the barrier layer 308 comprises MgO. The first FL 306 and the second FL 310 may each individually comprise cobalt iron (CoFe), cobalt boron (CoB), cobalt iron boron (CoFeB), cobalt hafnium (CoHf), cobalt iron hafnium (CoFeHf) or combinations thereof. The capping layer 312 may comprise Ta, Ru, Ti, CoHf. NiFe, W, or combinations thereof.

The DFL read head 300 further includes a first synthetic antiferromagnetic (SAF) soft bias (SB) side shield 315a that includes a first lower SB layer 316a, a first spacer 318a such as ruthenium (Ru), and a first upper SB layer 320a and a second SAF SB side shield 315b that includes a second lower SB layer 316b, a second spacer 318b such as ruthenium, and a second upper SB layer 320b. The SAF SB layers 316a, 316b, 320a, 320b may comprise NiFe, CoFe, or combinations thereof. The magnetic moments or magnetization directions for the first FL 306 and the second FL 310 may be antiparallel due to the antiparallel biasing from the SAF SB side shields 315a, 315b (collectively referred to as SAF SB side shields 315). The DFL read sensor 301 is insulated from SAF SB side shields 315 by insulation layers 314a, 314b (collectively referred to as insulation layers 314). The insulation layers 314 may be aluminum oxide (AlOₓ), magnesium oxide (MgO) or any other suitable insulation material, or combinations thereof.

As shown in FIG. 3B, the DFL read head 300 further includes a rear bias (RB) 346 and an insulation layer 342. The RB 346 is isolated electrically by the insulation layer 342 from the DFL read sensor 301 and the first shield 302. The insulation layer 342 may be aluminum oxide (AlOₓ), magnesium oxide (MgO), any other suitable insulation material, or combinations thereof. A bottom portion of the RB 346 disposed adjacent to the first shield 302 is spaced from the insulation layer 342 by a seed layer 344, where the seed layer 344 has a same width in the z-direction as the RB 346. The RB 346 is further insulated by the insulation layer 352 on the other side away from the DFL read sensor 301 (e.g., recessed from the MFS). The insulation layer 352 may be aluminum oxide (AlₓO_{y}) or any other suitable insulation material. The RB 346 generates a magnetic field pointing away or toward the following layers: the first FL 306, the barrier layer 308, the second FL 310, and the capping layer 312. The RB 346 is magnetically decoupled from the second shield 322 by inserting a capping layer 360 between RB 346 and the second shield 322. In some embodiments, the capping layer 360 is nonmagnetic and provides decoupling between RB 346 and the second shield 322. In some embodiments, the capping layer 360 has a etch rate of between about 0.5 Å/s and about 1.5 Å/s, such as 1 Å/s. The capping layer 360 is recessed from the MFS and is disposed adjacent to the capping layer 312.

The RB 346 may comprise CoPt, and in such cases, referred to as rear hard bias (RHB). The RB 346 may also comprise NiFe, CoFe, or combinations thereof, and in such cases, referred to as rear soft bias (RSB). Generally, both the material of the RB 346 (e.g. RHB) and the material of the RB 346 (e.g. RSB) or the SAF SB side shields 315 are polycrystalline. As such, the granular nature of the material of the RB 346 determines the degree of the intrinsic non-uniformity of the transverse bias fields depending on its magneto-crystalline anisotropy.

The RB 346 has a magnetization direction (e.g., in the z-direction) substantially perpendicular to a magnetization direction (e.g., in the x-direction) of the lower SB layers 316 (e.g., first and second lower SB layers 316a, 316b) and the upper SB layers 320 (e.g., first and second upper SB layers 320a, 320b). Before the magnetic recording head comprising the DFL read head 300 is shipped from the production line, the RB 346 typically needs to be magnetically initialized by a magnetic field in the z-direction.

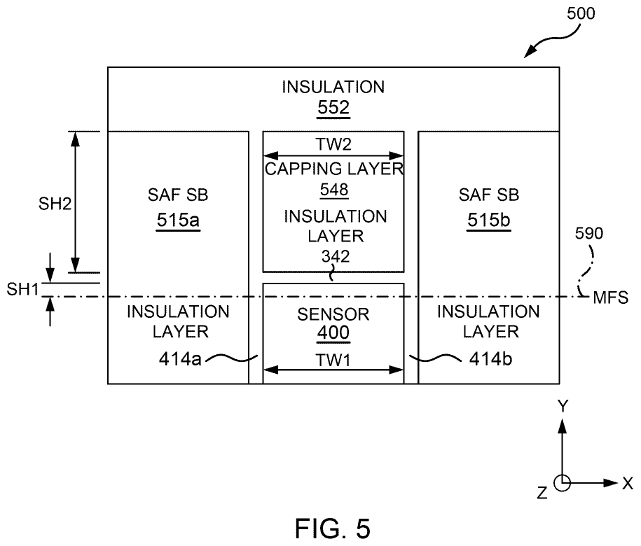

FIGS. 4A-4J illustrate a perspective view of a method of forming a DFL read head 500 with a shaped RB 546, according to one or more embodiments. FIG. 5 illustrates a top plan view of the DFL read head 500. FIG. 5 depicts a top plan view of DFL read head 500 after the method of forming a DFL read head with a shaped RB 546 described in FIGS. 4A-4I, according to one or more embodiments. The following description refers simultaneously to both the method of forming DFL read head 500 described in FIGS. 4A-4I, respectively. DFL read head 500 may be the DFL read head 300 of FIGS. 3A-3B; as such, aspects of the DFL read head 300 may be referred to herein. As such, the DFL sensor 400 may be the DFL sensor 301, capping layer 548 may be the capping layer 360, the RB 546 may be the RB 346, insulation layers 414a, 414 may be the insulation layers 314a, 314b, insulator 552 may be the insulation layer 352, the SAF SB side shields 515a, 515b may be the SAF SB side shields 315a, 315b, and second shield 522 may be the second shield 322. The DFL read head 500 may correspond to, or be a part of, the read/write head 200 described in FIG. 2, such as the magnetic read head 211.

As shown in FIGS. 4A-4C, a DFL sensor 400 (e.g., a DFL reader TMR sensor) is deposited. The DFL sensor 400 may be a multilayer structure, as described above, comprising a first shield (S1) 402, a seed layer 404 disposed on the first shield 402, a first free layer 406 disposed on the seed layer 404, a barrier layer 408 disposed on the first free layer 406, a second free layer 410 disposed on the barrier layer 408, a capping layer 412 disposed on the second free layer 410, and a stitch layer 422 layer disposed on the capping layer 412.

In some embodiments, the DFL sensor 400 is an in-stack TMR film with capping layer 412 (e.g., capping layer 312 of FIGS. 3A-3B). For example, the DFL sensor 400 may be a multilayer structure, comprising a first shield, a seed layer disposed on the first shield, a first free layer disposed on the seed layer, a barrier layer disposed on the first free layer, a second free layer disposed on the barrier layer, and a capping layer disposed on the second free layer, and a stitch layer 422 disposed on the capping layer 412. In some embodiments, stitch layer 422, in the in-stack TMR film comprises magnetic and non-magnetic materials (e.g., CoHf, Ru). In some embodiments, a stitch layer 422 in the in-stack TMR film comprises one or more of CoHf, Ru, NiFe, CoFe, Co, Fe, Ni, Ta, W, or Ti.

In some embodiments, the stitch layer 422 has an etch rate between about 1.5 Å/s and about 2.5 Å/s, such as 2 Å/s. The stitch layer 422 disposed on the capping layer 412 of the DFL sensor 400 may protect the DFL sensor 400 during the removal process of the exposed portions, as detailed in FIG. 4F. For example, via composition or thickness of the stitch layer 422, the stitch layer 422 may increase the overall time needed to etch or mill DFL sensor 400. That is, because stitch layer 422 is disposed on capping layer 412—when etching or milling the DFL sensor 400—a hardness due to the composition or thickness of stitch layer 422 increases the time needed to etch or mill through stitch layer 422 before etching or milling the capping layer 412, than without the protection of the stitch layer 422. Thus, including a stitch layer 422 in the the DFL sensor 400 stalls or decreases the overall etching rate of the DFL sensor 400. Further, by stalling the etch rate, the etch time of the DFL sensor 400 is increased, thereby overcoming different etch timings of the DFL sensor 400 versus the RB during the removal process. Thus, depositing a stitch layer over a DFL sensor to adjust the etch rate of the DFL sensor to match the etch rate of the capping layer, the RB, and the first shield layer during the milling/removal processes provides sufficient time to mill/remove exposed portions of the rear bias without damaging the DFL sensor, and in doing so, improves shaped RHB or RSB control and reliability in DFL sensors.

Upon depositing the capping layer 412 in FIG. 4A, the capping layer 412 of the DFL sensor 400 is milled (e.g., FIG. 4B) to define the shield to shield (S-S) spacing on the DFL sensor 400 prior to depositing the stitch layer 422, like shown in FIG. 4C. In some embodiments, the capping layer 412 of the DFL sensor 400 is removed. In some embodiments, stitch layer 422 is deposited in-situ with the DFL sensor 400, in which case the shield to shield spacing is defined by the deposited capping layer 412.

In FIG. 4C, a stitch layer 422 is formed in-situ on the capping layer 412. In some embodiments, the stitch layer 422 comprises one or more of NiFe, Ta, Ru, and W.

In FIG. 4D, a first photoresist 430 is deposited on a portion of the DFL sensor 400. The first photoresist 430 is deposited on a front portion or front half of the DFL sensor 400. The first photoresist 430 extends across the width of the DFL sensor 400 in the x-direction.

FIG. 4E shows the result after multiple processes are applied to FIG. 4D. First, the back portion 480 or the exposed portion of the DFL sensor 400 of FIG. 4D except the first shield 402 is milled or removed to define a stripe height (SH1) in the z-direction of the DFL sensor 400, leaving only the portion of the DFL sensor 400 covered by the first photoresist 430 and the first shield 402. Then, after a thin insulation layer 442 (e.g., insulation layer 342 of FIG. 3B) is deposited adjacent to the portion of the DFL sensor 400 covered by the first photoresist 430, capping layer 548 (e.g., capping layer 360 of FIG. 3B) and RB 546 are formed adjacent to and in contact with the insulation layer 442 and over the first shield 402, with the capping layer 548 disposed over the RB 546. As previously shown in FIG. 3B, the RB 346 may be disposed over the seed layer 344 and a portion of the insulation layer 342 (both not shown in FIG. 4E) over the first shield 302. The RB 546 is recessed from the MFS, where the portion of the DFL sensor 400 uncovered by the first photoresist 430 previously was. In some embodiments, the RB 546 may comprise CoPt as a RHB, or NiFe, CoFe, Ta, W, or combinations thereof as a RSB. The first photoresist 430 is then removed. FIG. 4E thus shows the state of the process after removal of the first photoresist 430, after the several processes described above.

In some embodiments, the SH1 of the DFL sensor 400 and a stripe height (SH2) of the RB 546 in the z-direction each individually has a height of about 100 nm to about 1000 nm. However, after the formation of the MFS (shown by the dashed line 590 in FIGS. 5A-5B), for example, formed via slider fabrication by row lapping and ion milling processes, stripe height (SH1) has a height of about 15 nm to about 30 nm and stripe height (SH2) has a height of about 100 nm to about 1000 nm.

In FIG. 4F, a hard mask stencil 432 defined by a second photoresist is formed on the stitch layer 422 of DFL sensor 400 and the capping layer 548 to define a track width (TW1) in the x-direction of both the DFL sensor 400 and the capping layer 548. The hard mask stencil 432 extends from the MFS to a surface 560 of the capping layer 548, RB 546, and first shield 402 opposite the MFS. The hard mask stencil 432 may have a width in the x-direction of about 15 nm to about 30 nm±about 2 nm.

FIG. 4G shows the results of several processes after FIG. 4F. First, the exposed portions or side portions (i.e., the portions not covered by the hard mask stencil 432) of both the DFL sensor 400 (including stitch layer 422), capping layer 548, RB 546, and first shield 402 are milled or removed, leaving only the portions of the DFL sensor 400, capping layer 548, RB 546, and first shield 402 covered by the hard mask stencil 432. Removing the exposed portions of the RB 546 shapes the read bias of the RB 546. In some embodiments, upon removing the exposed portions, the DFL sensor 400 and the RB 546 have a defined track width in the x-direction. The track width (TW1) of the DFL sensor 400 and the track width (TW2) of the RB 546 are substantially the same with a width of about 10 nm to about 30 nm±about 2 nm. Second, the DFL sensor 400 is insulated from SAF SB side shields 515a, 515b by insulation layers 414a, 414b (e.g., insulation layers 314a, 314b of FIG. 3A), collectively referred to as insulation layers 414. Insulation layers 414 are deposited adjacent to the DFL sensor 400 and the RB 546 in the x-direction and the −x-direction. Third, the SAF SB side shields 515a, 515b are then formed over insulation layers 414a, 414b and adjacent to the DFL sensor 400, capping layer 548, RB 546, and first shield 402 in the x-direction and the −x-direction. The SAF SB side shields 515a, 515b may be multilayer structures, as described above, comprising NiFe, CoFe, Ru, or combinations thereof. The SAF SB side shields 515a, 515b have a stripe height (SH3) in the z-direction equal to the sum of the stripe heights SH1 and SH2 of the DFL sensor 400, the capping layer 548, and the width of the insulation layer 442. Each of the SAF SB side shields 515a, 515b has a track width in the x-direction of about 500 nm to about 1000 nm, which is greater than both the DFL sensor 400 and the capping layer 548. Fourth, the hard mask stencil 432 is removed. FIG. 4G shows the state after this fourth process.

In FIG. 4H, a third photoresist 444 is deposited on a portion of the DFL sensor 400 (e.g., stitch layer 422). The third photoresist 444 is deposited on a front portion or front half of the DFL sensor 400, SAF SB side shields 515a, 515b, and insulation layers 414a, 414b. The third photoresist 444 extends across the width of the SAF SB side shields 515a, 515b including the DFL sensor 400 and insulation layers 414a, 414b in the x-direction. The third photoresist 444 exposes the rear portion or rear half of the SAF SB side shields 515a, 515b and insulation layers 414a, 414b, and exposes capping layer 548, RB 546, first shield 402, and insulation layer 442.

In FIG. 4I, the exposed rear portion or rear half of the SAF SB side shields 515a, 515b and insulation layers 414a, 414b, as well as the exposed capping layer 548, RB 546, first shield 402, and insulation layer 442, are milled or removed and then refilled with insulator 552 to redefine strip height (SH2). Thus, capping layer 548 and RB 546 is further insulated by insulator 552 (e.g., insulation layer 352 of FIG. 3B) on the side away from the DFL sensor 400 (e.g., recessed from the MFS).

In FIG. 4J, a second shield 522 is stitched to the stitch layer 422, and the second shield 522 is disposed over the exposed DFL sensor 400 and capping layer 548, as well as the SAF SB side shields 515a, 515b and insulator 552. In some embodiments, prior to stitching the second shield 522 to stitch layer 422, an optional removal step may be implemented to mill or etch the DFL read head 500 in the y-direction to thin down the DFL read head 500. In some embodiments, the second shield 522 comprises a ferromagnetic (FM) layer 524, an antiferromagnetic layer (AFM) layer 526, and a cap layer 528. FM layer 524 is disposed over the exposed DFL sensor 400 and capping layer 548, as well as the SAF SB side shields 515a, 515b. AFM layer 526 is disposed over the FM layer 524. Cap layer 528 is disposed over the AFM layer 526. In some embodiments, FM layer 524 comprises one or more of NiFe, NiFe/CoFe laminates, NiFe/NiFeCr laminates, and NiFe/W laminates. In some embodiments, AFM layer 526 comprises IrMn or IrCrMn. In some embodiments, cap layer 528 comprises one or more of Ta, Ru, Ti, and W.

Forming DFL read head 500 as described in FIGS. 4A-4I, respectively, allows the DFL sensor 400, the capping layer 548, and RB 546 to be self-aligned, as the track width of the DFL sensor 400, capping layer 548, and RB 546 is defined at the same time. Furthermore, the RB 546 is shaped to match the DFL sensor 400, which induces shape anisotropy. The shaped RB 546 further increases the transverse magnetic anisotropy to align bias element magnetization along the z-direction and allow a consistent and effective transverse bias field to be delivered to DFL read head 500. The increased transverse magnetic anisotropy thus improves bias point control and reliability of the DFL read head 500, enabling smaller track width (e.g., less than about 20 nm) of DFL read head 500 with ensured performance. Furthermore, the method of forming DFL read head 500 further allows for better shield to shield control with process step reduction. Additionally, rear bias decoupling to the second shield layer is ensured by avoiding excessive milling when defining shield to shield spacing, and when defining the capping layer for seamless connection between the SAF SB and second shield layer. Lastly, more magnetic materials are viable for the rear bias due to the minimization of a low milling rate based on capping layer material or thickness, which in turn ensures that the track width of the rear bias is well defined during track width defining milling.

### EXAMPLES

The following non-limiting examples are provided to further illustrate implementations described herein. However, the examples are not intended to be all-inclusive and are not intended to limit the scope of the implementations described herein.

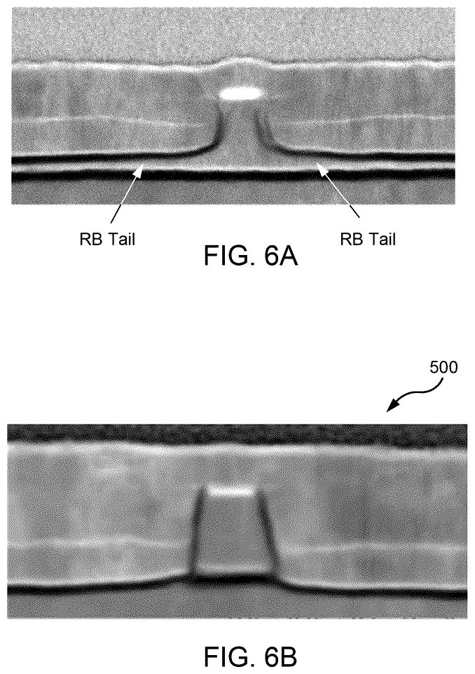

FIGS. 6A-6B depict photos demonstrating the milling/removal of the exposed portions of the rear bias, according to one or more embodiments. The DFL read head 500 of FIG. 6B is the DFL read head 500 described in FIG. 4A and FIG. 5. As shown in the conventional DFL sensor of FIG. 6A (prior art), the milling time or removal time of exposed portions of rear bias are greater than the milling time or removal time of exposed portions of the DFL sensor. Since the rear bias takes longer to mill than the DFL sensor, a rear bias “tail” remains after the milling/removal process. However, as shown in FIG. 6B, depositing the stitch layer 422 over the DFL sensor 400 to adjust the etching rate of the DFL sensor to match the etching rate of the RB during the milling/removal processes provides sufficient time to mill/remove exposed portions of the rear bias. Thus, no rear bias “tail” remains after the milling/removal process; thereby, improving shaped RHB or RSB control and reliability in DFL sensors.

In one embodiment, a method of forming a dual free layer (DFL) read head includes forming a DFL sensor, the DFL sensor being disposed at a media facing surface; disposing a stitch layer over the DFL sensor; forming a rear bias (RB) adjacent to the DFL sensor, the RB being recessed from the media facing surface; and defining portions of the stitch layer, the DFL sensor, and the RB, an etch rate of the stitch layer being equal to or greater than an etch rate of the RB.

The stitch layer is configured to decrease the etch rate of defining a portion of the stitch layer and DFL sensor. The etch rate of defining the portion of the stitch layer and DFL sensor is equal to the etch rate of defining a portion of the RB. The stitch layer comprises NiFe, Ta, Ru, W, or combinations thereof. The defined portions of the stitch layer, the DFL sensor, and the RB have a track width, the track width of the stitch layer, the DFL sensor, and the RB being the same. Dispose a RB capping layer over the RB before the defining step. Stitch a shield layer to the stitch layer. The RB capping layer has an etch rate of between 0.5 Å/s and 1.5 Å/s. Dispose a capping layer over the DFL sensor and define a shield to shield spacing of the DFL sensor prior to disposing the stitch layer over the DFL sensor, wherein the stitch layer is disposed over the capping layer. A magnetic recording device comprising a DFL read head formed by the method.

In another embodiment, a dual free layer (DFL) read head includes a DFL sensor, the DFL sensor being disposed at a media facing surface, the DFL sensor comprising a first shield, two free layers disposed over the first shield, and a second shield disposed over the two free layers; a stitch layer disposed over the DFL sensor, the stitch layer having an etch rate that is lower than that of other layers in the DFL sensor; and a rear bias (RB) adjacent to the DFL sensor, the RB being recessed from the media facing surface.

The stitch layer comprises NiFe, Ta, Ru, W, or combinations thereof. A removal rate of the stitch layer is equal to or greater than a removal rate of the RB. A RB capping layer disposed over the RB and under the second shield, wherein the second shield is stitched to the stitch layer. The stitch layer has an etch rate of between 1.5 Å/s and 2.5 Å/s. Dispose a capping layer between the DFL sensor and the stitch layer. A magnetic recording device comprising the DFL read head.

In yet another embodiment, a dual free layer (DFL) read head includes a means for reading data disposed at a media facing surface (MFS), the means for reading data comprising: a first shield; a seed layer disposed over the first shield; a first free layer disposed over the seed layer; a barrier layer disposed over the first free layer; a second free layer disposed over the barrier layer; a second shield disposed over the second free layer; and a stitch layer disposed over the second free layer; and a rear bias (RB) adjacent to the means for reading data, the RB being recessed from the media facing surface.

The stitch layer is configured to decrease a removal rate of the means for reading data, so that it is greater than or equal to a removal rate of the RB. A capping layer between the stitch layer and the second free layer. The second shield is stitched to the stitch layer, and further comprising a RB capping layer between the RB and the second shield. A magnetic recording device comprising the DFL read head.

While the foregoing is directed to embodiments of the present disclosure, other and further embodiments of the disclosure may be devised without departing from the basic scope thereof, and the scope thereof is determined by the claims that follow.

1. A method of forming a dual free layer (DFL) read head, comprising:
forming a DFL sensor, the DFL sensor being disposed at a media facing surface;
disposing a stitch layer over the DFL sensor;
forming a rear bias (RB) adjacent to the DFL sensor, the RB being recessed from the media facing surface; and
defining portions of the stitch layer, the DFL sensor, and the RB, an etch rate of the stitch layer being equal to or greater than an etch rate of the RB.

2. The method of forming the DFL read head of claim 1, wherein the stitch layer is configured to decrease the etch rate of defining a portion of the stitch layer and DFL sensor.

3. The method of forming the DFL read head of claim 2, wherein the etch rate of defining the portion of the stitch layer and DFL sensor is equal to the etch rate of defining a portion of the RB.

4. The method of forming the DFL read head of claim 1, wherein the stitch layer comprises NiFe, Ta, Ru, W, or combinations thereof.

5. The method of forming the DFL read head of claim 1, wherein the defined portions of the stitch layer, the DFL sensor, and the RB have a track width, the track width of the stitch layer, the DFL sensor, and the RB being the same.

6. The method of forming the DFL read head of claim 1, further comprising disposing a RB capping layer over the RB before the defining step.

7. The method of forming the DFL read head of claim 1, further comprising stitching a shield layer to the stitch layer.

8. The method of forming the DFL read head of claim 7, wherein the RB capping layer has an etch rate of between 0.5 Å/s and 1.5 Å/s.

9. The method of forming the DFL read head of claim 1, further comprising disposing a capping layer over the DFL sensor and defining a shield to shield spacing of the DFL sensor prior to disposing the stitch layer over the DFL sensor, wherein the stitch layer is disposed over the capping layer.

10. A magnetic recording device comprising a DFL read head formed by the method of claim 1.

11. A dual free layer (DFL) read head, comprising:
a DFL sensor, the DFL sensor being disposed at a media facing surface, the DFL sensor comprising a first shield, two free layers disposed over the first shield, and a second shield disposed over the two free layers;
a stitch layer disposed over the DFL sensor, the stitch layer having an etch rate that is lower than that of other layers in the DFL sensor; and
a rear bias (RB) adjacent to the DFL sensor, the RB being recessed from the media facing surface.

12. The DFL read head of claim 11, wherein the stitch layer comprises NiFe, Ta, Ru, W, or combinations thereof.

13. The DFL read head of claim 11, wherein a removal rate of the stitch layer is equal to or greater than a removal rate of the RB.

14. The DFL read head of claim 11, further comprising a RB capping layer disposed over the RB and under the second shield, wherein the second shield is stitched to the stitch layer.

15. The DFL read head of claim 11, wherein the stitch layer has an etch rate of between 1.5 Å/s and 2.5 Å/s.

16. The DFL read head of claim 11, further comprising disposing a capping layer between the DFL sensor and the stitch layer.

17. A magnetic recording device comprising the DFL read head of claim 11.

18. A dual free layer (DFL) read head, comprising:
a means for reading data disposed at a media facing surface (MFS), the means for reading data comprising:
a first shield;
a seed layer disposed over the first shield;
a first free layer disposed over the seed layer;
a barrier layer disposed over the first free layer;
a second free layer disposed over the barrier layer;
a second shield disposed over the second free layer; and
a stitch layer disposed over the second free layer; and
a rear bias (RB) adjacent to the means for reading data, the RB being recessed from the media facing surface.

19. The DFL read head of claim 18, wherein:
the stitch layer is configured to decrease a removal rate of the means for reading data, so that it is greater than or equal to a removal rate of the RB.

20. The DFL read head of claim 18, further comprising a capping layer between the stitch layer and the second free layer.

21. The DFL read head of claim 18, wherein the second shield is stitched to the stitch layer, and further comprising a RB capping layer between the RB and the second shield.

22. A magnetic recording device comprising the DFL read head of claim 18.
